(19) United States
(12) Patent Application Publication
(10) Pub. No.: US 2025/0053789 A1
(43) Pub. Date: Feb. 13, 2025

(54) INTELLIGENT FORECASTING WITH LIMITED DATA AVAILABILITY UTILIZING EMBEDDINGS FROM AUTO-ENCODERS AND MACHINE LEARNING MODELS

(71) Applicant: PAYPAL, INC., San Jose, CA (US)

(72) Inventors: Satyabrata Mishra, Bengaluru (IN); Vinay Teja Gadikatla, Anantapur (IN); Venkata Subramanian Selvaraj, Chennai (IN); Thejaswin Sivakumar, Maraimalai Nagar (IN)

(21) Appl. No.: 18/472,129

(22) Filed: Sep. 21, 2023

(30) Foreign Application Priority Data
Aug. 10, 2023 (IN) 202341053822

(51) Int. Cl. G06N 3/0455

(52) U.S. Cl. CPC G06N 3/0455

(57) ABSTRACT

There are provided systems and methods for intelligent forecasting with limited data availability utilizing embeddings from auto-encoders and machine learning models. A service provider, such as an electronic transaction processor for digital transactions, may provide computing services to users. In order to provide actionable insights into users, accounts, and/or activities associated with the service provider, such as to provide computing or other services to users, the service provider may utilize DNNs and other ML models that are trained for forecasting. The models may be trained by encoding vectors from initial training data using an encoder having an embedding, attention, and LSTM layer, which may retain temporal aspects to data for users or groups that have limited past data availability. Once trained, the models may be used to determine risk and/or engagement scores of users, which may predict or forecast users' future actions to offer services to the users.

### CROSS REFERENCE TO RELATED APPLICATION

The present invention claims priority to India Provisional Patent Application Serial No. 202341053822, filed Aug. 10, 2023, which is incorporated herein by reference in its entirety.

### TECHNICAL FIELD

The present application generally relates to machine learning (ML), neural network (NN), or other AI forecasting, and more particularly to providing accurate forecasting with limited data availability.

### BACKGROUND

Online service providers may provide services to different users, such as individual end users, merchants, companies, and other entities. For example, online transaction processors may provide electronic transaction processing services. When providing these services, the service providers may provide an online platform that may be accessible over a network, which may be used to access and utilize the services provided to different users. The service providers may use intelligent decision-making operations to make comparisons with past occurrences, which may be helpful in assisting customers and/or providing computing and other services, features, or products in a predictive manner. However, conventional ML, NN, and/or AI models require a specific set of features and sufficient input data to properly train and utilize models and systems for accurate forecasting. Certain users and entities may not have sufficient past data related to the prediction or other future behavior, activity, or action to be forecasted, resulting in such models making inaccurate predictions or incapable of forecasting. Thus, conventional ML, NN, or AI-based operations for training and predicting may be insufficient to adequately handle scenarios with limited data availability.

Therefore, there is a need for more accurate and efficient ML, NN, or other AI-based systems that provide more accurate intelligent forecasting, predicting, and decision-making for future user actions.

### BRIEF DESCRIPTION OF THE DRAWINGS

FIG. 1 is a block diagram of a networked system suitable for implementing the processes described herein, according to an embodiment;

FIGS. 2A-2E are exemplary computing architectures for a model training system and training components used to train ML models to forecast predictions based on vectors generated using limited data availability, according to an embodiment;

FIG. 3A-3C are exemplary diagrams of product descriptions from items in purchase histories of past purchases that may be used to encode vectors for forecasting of future user actions by ML models, according to an embodiment;

FIGS. 4A-4B are exemplary flowcharts for intelligent forecasting with limited data availability utilizing embeddings from auto-encoders and machine learning models; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for intelligent forecasting with limited data availability utilizing embeddings from auto-encoders and machine learning models. Systems suitable for practicing methods of the present disclosure are also provided.

In network communications, such as between online platforms and systems for service providers and end user devices, electronic platforms and computing architecture may provide computing services to users and computing devices. For example, online transaction processors may provide computing and data processing services for electronic transaction processing between two users or other entities (e.g., groups of users, merchants, businesses, charities, organizations, and the like). In order to assist in providing computing services to users, customers, merchants, and/or other entities, services providers may attempt to forecast or predict actions, activities, behaviors, and/or interests of users. For example, such forecasts or predictions may be associated with accounts, activities, behaviors, actions, marketing, and the like based on past collected and/or aggregated data of the user and other users. Intelligent forecasting or predictions may lead to desired and actionable decisions on extensions of computing services and the like to different users. In order to do so, a service provider may classify and/or correlate customers, accounts, or the like based on available data and using trained AI models, such as ML and/or NN models and systems. However, deriving desired and actionable predictions require specific past behavior to be accurate and efficient. This may not be available for certain users and/or classes, types, or demographics of users, such as new users to a system, users that have limited historical activity data for past activities, and the like. Thus, service providers may not properly forecast or predict user actions and the like for different users or accounts to provide optimized actionable decisions for customers.

In this regard, a service provider may utilize embeddings or vectors of data generated by a layer of a deep neural network model of an encoder for the system in order to better train and utilize ML or NN models for forecasting of user actions, activities, behaviors, and/or interests. ML and NN models and systems may be trained using training data having data records designated for training and/or features or variables of the corresponding model. Data records may correspond to data in one or more data tables that include different parameters and/or features. For example, a data record may include a row in a data table having features from a set of features corresponding to the different columns of the data table. For data records associated with past purchases or other past payment and transaction information, users may have records that each may include an account, a processed transaction, an amount, transaction items, etc., which may be found in the columns for the corresponding data record in a row. The features and/or data records may also have a corresponding temporal factor, dimensionality, and/or information, such as activities and/or actions taken over time (e.g., processed transactions over a time period, changing account balance, etc.).

However, conventional training data and features for ML and NN model training by service providers may utilize specific information and data records, such as a bank account history or other financial history when predicting credit worthiness, loan worthiness and/or likelihood or repayment or default at a future time. These data records may be unavailable for specific users and/or groups of users. Thus, as discussed herein, the service provider may utilize an encoder-decoder pair to train a deep neural network (DNN) model and/or framework to provide deep temporal-based forecasts or likelihood of actions by a user (e.g., likelihood of meeting or failing to meet a condition for a service, such whether a user may fail to meet a required stipulation of the service including loan or credit services). The encoder may use an embedding layer, an attention layer, and a long short-term memory (LSTM) recurrent neural network (RNN) architecture layer to encode the features and feature's data from what training data that is available and specified for the user, which allow for training the DNN model with a reduced dimensionality to input features and data. In further embodiments, other neural networks (NNs), machine learning (ML) models, and other artificial intelligence (AI) systems and models may also be used. The decoder may be used to ensure that the input vector resembles and/or is correlated to the original features and feature data when decoded. The DNN model may be trained for a predictive score, classification, or output variable associated with input features. For example, a forecast, such as the score, decision, or other value, may further be used to classify or categorize a likelihood of a future action by a user. For example, the output score, value, or variable by the DNN model may be associated with a default likelihood or risk of default of a user defaulting or being unable to pay and/or meet a condition of credit or a loan extended to the user. This may be at future times or time steps, such as 6, 12, 18, or 24 months in the future.

Further, the score may be used to increase or decrease a credit limit and/or loan application amount extended to the user based on the default likelihood or other risk of being unable to meet a condition or requirement for a loan, credit, or other amount and/or service extended to the user. The score may be associated with a future engagement of the user with an online transaction processor or other service provider, such as how likely the user is to utilize such service provider in the future. The score may be used for marketing the other service provider products to the users based on their future predicted engagement with the service provider and default likelihood. As another example, the score may be associated with customer's life time value, which can be used to provide incentives to retain high value customers.

In this regard, a service provider may provide electronic transaction processing to users and entities through digital accounts, including consumers and merchants that may wish to process transactions and payments and/or perform other online activities. The service provider may also provide computing services, including email, social networking, microblogging, media sharing, messaging, business and consumer platforms, etc. In order to establish an account, these different users may be required to provide account details, such as a username, password (and/or other authentication credential, such as a biometric fingerprint, retinal scan, etc.), and other account creation details. The account creation details may include identification information to establish the account, such as personal information for a user, business or merchant information for another entity, or other types of identification information including a name, address, and/or other information. The entity may also be required to provide financial or funding source information, including payment card (e.g., credit/debit card) information, bank account information, gift card information, benefits/incentives, and/or financial investments, which may be used to process transactions. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services.

An online transaction processor or other service provider may execute operations, applications, decision services, and the like that may be used to process transactions between two or more users or entities. Further, the service provider may provide financial services associated with the computing services to users, such as provision of payment cards, extensions of credit or loans, and the like. When providing services to users or other entities, as well as making other business decisions, the service provider may utilize AI systems, such as ML models and NNs, to extend services and/or provide recommendations, actions, marketing or advertisement, and the like in a predictive manner. This may be done using a trained ML model or NN when the service provider lacks or has limited data availability for past activities, actions, and/or histories of users.

The service provider may train a DNN or other ML model for a predictive output or classification using vectors encoded from embedding having weights based on a self-attention layer that are generated using past activities of users, accounts, entities, or the like. In order to train the DNN or other ML models, training data for the models may be collected and/or accessed. The training data may correspond to a set or collection of features from some input data records, which may be associated with users, customers, accounts, activities, entities, and/or the like. The training data may be collected, aggregated, and/or obtained for a particular predictive output and/or classifications by the DNN. For example, a DNN may be associated with classifying users or accounts, predicting whether the users or accounts will engage in a behavior and/or perform an action at a future time, or the like. This may be based on users that have limited data for certain past activities and/or parameters, such as limited historical bank or other financial account data. Further, an engagement score associated with whether the user is engaged or not engaged with the service provider (e.g., utilizes or is engaged with usage of the service provider based on past behaviors and the like) may be predicted by such model. In this manner, and similar to default risk that may be related to future time-steps, such as 12, 18, 24, etc. months, engagement score precited using the model may also be related to future time-steps, such as 12, 18, 24, etc. months.

Such scores and predictions may be used to determine whether to extend a service to a user, such as whether the user is likely to meet or fail to meet a condition of the service, default or fail to meet a stipulation of the service, or otherwise perform a future action. For example, the DNN risk score and user's engagement score may be used to determine a user's credit worthiness and/or whether a loan or credit to the user, such as a default risk or likelihood of defaulting on the loan or credit at a future time (e.g., 6-months in the future or at another repayment time). The training data may be associated with past purchases of the user over a time period, including frequency of purchases, amounts, totals, items purchased, purchase locations, merchant, and the like. As such, the data records may include item purchase information, such as a transaction history of the user.

The service provider may reduce a dimensionality of the input features for training and utilizing the DNN or other ML model through use of encoded vectors representing the input features and data. In this regard, the service provider may utilize an encoder-decoder pair, which may correspond to a component configured to encode the vectors and thereafter decode the vectors to check loss from encoding and whether the encoded vectors adequately and/or correctly represent the features and data. The encoder may utilize an embedding layer that may embed data for the features to numerical representations in a data table or matrix, where the encoded data may correspond to a mathematical representation of the data for the features. This may be done through one-hot encoding for categorical features and the like where the features are not initially represented in a mathematical form for processing. While embedding into a mathematical representation, the encoder may apply an attention layer having a self-attention mechanism. The self-attention mechanism may function to utilize weights that are applied at item/embedding level, where each embedding of each item is provided as input to each unit of the self-attention mechanism. The encoder may check a similarity of one item with other items that were given as input to other units of the self-attention mechanism. Thus, the weights may indicate how similar each item is with other items from the past activity data, such as purchase history, which may be used when calculating the embedding for each item.

Thus, initially the service provider may receive or access training data to perform these classifications and/or categorizations for future forecasting and predicting of user activity, actions, or behaviors, such as default likelihood on a credit or loan extension. However, when training, an encoder of an encoder-decoder pair may be used that includes layers, such as embedding layer(s), to generate vectors for initial training data for ML model or DNN training. The embedding layer may generate the embeddings with attention focus from a self-attention layer. These embeddings may correspond to vectors that reduce the dimensionality of the input feature data for the input features selected for training. The embeddings allow for time-sensitive data processing, which allows similarities and relationships between users, accounts, activities, or the like to be deduced based on the temporal data records. For example, the features may correspond to credit bureau features and data relevant for such financial institutions to make decisions on credit worthiness, which may further be associated with a user's transaction history over a period of time.

The embeddings with self-attention weights and focus from training data for the ML model or DNN training may further use an LSTM architecture and framework to generate training vectors that include a time-sensitive or temporal focused factor, which may be used for future predictions and forecasts. For example, when training the model, an LSTM layer of the encoder that is based on an LSTM algorithm may be used to generate vectors associated with training data for predictions and other decision-making, such as a predictive score or classification. The LSTM layer may therefore provide a vector of n-dimensionality, where n corresponds to a reduced number and dimensionality from the input features. Thus, the vector is used to reduce the individual data points or features for the corresponding data records (e.g., by reducing the number of individual data pieces for the data record).

LSTM layer may be used in order to provide a temporal dimension to the input feature data and corresponding features or variables when generating the vector. After vector generation, a decoder of the encoder-decoder pair may be used to check loss from vector encoding. The decoder may decode the vector from the encoder to obtain the embedding and/or initial feature data. For example, a 32-dim encoded vector may reduce the dimensionality of the input features from hundreds (e.g., 100-500 individual features and values, which may further be multiplied by the number of time steps) to 32 or other similarly reduced dimensions to the vector. If the embeddings and/or feature data is returned in the same or similar form and/or content (e.g., within a threshold change or loss function allowability), the vector may be considered sufficient for training. However, if not, the encoder may be flagged for review and further configuring in order to better encode vectors that represent the underlying features and feature data. When training using vectors, the DNN or other ML model may be trained until parameters and/or accuracy is sufficiently met, and thereafter deployed in a production computing environment.

Once the forecasting DNN or other ML model is trained, an output layer may be used for output decision or predictive scores. Data records for users, accounts, entities, activities, or the like may be accessed and used with the trained model. However, as the model was trained using input vectors generated by the encoder, similar input data may be required and at least the encoder or the encoder-decoder pair may be utilized to generate input vectors for forecasting of a user's future activity, behavior, or actions. Embeddings may be generated by the embedding layer with the attention layer providing weights from a self-attention mechanism. The LSTM layer may generate vectors, which may then be used for predictive outputs and decision-making, such as by forecasting a future feature associated with or action by the user. Such predictive outputs may correspond to a risk score or assessment, which may indicate a user's future likelihood of failure to meet a commitment or condition for a service offered to the user, likelihood to default or fail to meet a required stipulation (e.g., future payment or other requirement of a loan or credit service), or otherwise future action by the user.

As such, the forecasting DNN or other ML model may be used to forecast future likelihood of activity, behavior, or action by the user, which may be associated with the user utilizing or receiving a service, including financial services of the service provider. Output scores may be used by the service provider to determine whether to provide or offer the service to the user. Further, an engagement score of the user with the service provider or another service utilized by the service provider may be determined by the DNN or other ML model and used when determining whether to provider or offer the service to the user. An engagement score may be associated with usage and/or metric used to measure engagement of a customer or other user with a particular service provider and/or service. For example, a high engagement score may indicate that the user is highly engaged and likely to value retaining use of the service provider and/or service without defaulting or abandoning use. As such, the engagement score may further be utilized to determine a credit worthiness or other likelihood of the user's future action or activities. Thus, the service provider may make more accurate and efficient decisions of service provision, while reducing required data input. For example, the service provider may make accurate decisions even with users having limited past data availability for particular areas, user groups, and/or domains that lack or have limited past available data. Further, by encoding smaller vectors with reduced dimensionality, the DNN or other ML model may make more efficient decisions, which retain accuracy, thereby minimizing input and storage data size.

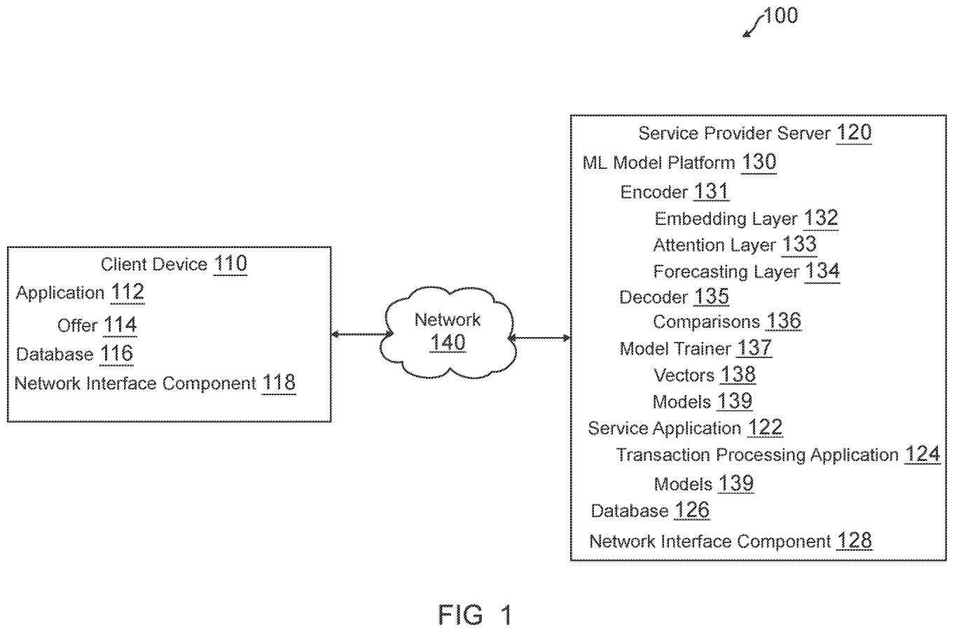

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by a user or another entity to interact with service provider server 120 over network 140, where service provider server 120 may provide various computing services, data, operations, and other functions over network 140. In this regard, client device 110 may perform activities with service provider server 120 for account establishment and/or usage, electronic transaction processing, and/or other computing services. Service provider server 120 may receive feature data for a DNN or other ML model that corresponds to data records associated with a user, account, or the like. Service provider server 120 may then make intelligent predictions and forecasts of future user actions based on the trained DNN or other ML model using an encoder-decoder that allows encoder data from limited data domains.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as computing and/or communication devices that may utilize appropriate hardware and software configured for wired and/or wireless communication with service provider server 120. For example, in one embodiment, one or more of client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although a single device is shown and described herein, a plurality of devices may function similarly and/or be connected to provide the functionalities described herein.

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may include one or more processes to execute software modules and associated components of client device 110 to provide features, services, and other operations to users from service provider server 120 over network 140, which may include account, electronic transaction processing, and/or other computing services and features from service provider server 120. In this regard, application 112 may correspond to specialized software utilized by a user of client device 110 to access a website or application (e.g., mobile application, rich Internet application, or resident software application) that may display one or more user interfaces that allow for interaction with service provider server 120, for example, to access and account, process transactions, and/or otherwise utilize computing services, which may include receiving an offer 114 based on a computing risk score and/or engagement score that predicts future actions or activity of a user. In various embodiments, application 112 may correspond to one or more general browser applications configured to retrieve, present, and communicate information over the Internet (e.g., utilize resources on the World Wide Web) or a private network. For example, each of application 112 may provide a web browser, which may send and receive information over network 140, including retrieving website information, presenting the website information to the user, and/or communicating information to the website. However, in other embodiments, application 112 may correspond to one or more dedicated applications of service provider server 120 or other entity (e.g., a merchant) for transaction processing via service provider server 120.

Application 112 may be associated with account information, user financial information, and/or purchase activity and historical purchase data for electronic transaction processing, including processing transactions using financial instrument or payment card data. Such data may correspond to feature data that may be used to train or as input to one or more DNN or other ML models for predictions and classifications. Feature data may include one or more data records, which may be stored and/or persisted in a database and/or data tables accessible by service provider server 120. Application 112 may be utilized to enter, view, and/or process items the user wishes to purchase in a transaction. In this regard, application 112 may provide transaction processing through a user interface enabling the user to enter and/or view the items that the users associated with client device 110 wish to purchase. Thus, application 112 may also be used by a user to provide payments and transfers to another user or merchant, which may include receiving a credit or loan extension with offer 114. Application 112 may also be used to receive a receipt or other information based on transaction processing. Further, additional services may be provided via application 112, including social networking, media posting or sharing, microblogging, data browsing and searching, online shopping, and other services available through service provider server 120. In some embodiments, the services provided via application 112 may be associated with receipt of offer 114 having service offers, marketing, recommendations, and/or other messages to provide an offer of an available service (e.g., credit or loan), increase customer engagement, and/or otherwise provide services using operations of service provider server 120.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying users/client device 110 to service provider server 120. Moreover, database 116 may store and/or provide data used during determination and provision of offer 114, such as data processed by one or more DNN or other ML models for forecasting of actions.

Client device 110 includes network interface component 118 adapted to communicate with service provider server 120 and/or another device or server. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide operations for use of services provided by service provider server 120 including account and electronic transaction processing services that may be offered to users depending on risk and/or engagement scores intelligently determined using a trained DNN or ML model. In this regard, service provider server 120 includes one or more processing applications which may be configured to interact with client device 110 to provide computing and customer services, where offers and extensions of service may be provided using the aforementioned AI models and systems. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes an ML model platform 130, service applications 122, a database 126, and a network interface component 128. ML model platform 130 and service applications 122 may correspond to executable processes, procedures, and/or applications with associated hardware. In other embodiments, service provider server 120 may include additional or different modules having specialized hardware and/or software as required.

ML model platform 130 may correspond to one or more processes to execute modules and associated specialized hardware of service provider server 120 to provide computing services to data scientists, administrators, and/or other users that may be used to generating models 139 that may be deployed with service application 122 to provide and/or offer services to users based on forecasting, as well as creating vectors for DNN or other ML model usage after deployment. In this regard, ML model platform 130 may correspond to specialized hardware and/or software used by a user associated with client device 110 to utilize one or more services for generating, tuning, and deploying encoder-decoders for use with DNN or other ML model training. For example, ML model platform 130 includes an encoder 131 and a decoder 135 functioning as effectively a pair for vector encoding and decoding, respectively, when training and utilizing the corresponding model. Encoder 131 may include an embedding layer 132, an attention layer 133, and/or a forecasting layer 134 or other architecture for vector encoding and generation from training data, and decoder 135 may utilize operations to decode such encoded vectors to determine loss from encoding and whether encoder 131 properly generates representative vectors for model training.

For example, models 139 may include DNN, ML, or other AI models trained using training data associated with different data records that may be from users having limited historical data and therefore may not include or have limited inclusion of relevant past history. In this regard, the data records may be associated with features from past purchase histories or other historical activities of a user. When building models 139, training data may be used to generate one or more classifiers and provide forecasts, predictions, or other outputs associated with a risk score of a user meeting or failing to meet a condition or stipulation, or otherwise conducting a future action, based on those classifications and an ML or NN model algorithm and/or trainer. The training data may be used to determine features and corresponding feature data, such as through feature data extraction from the input training data.

Encoder 131 utilizes the extracted feature data to first create embeddings of the data using embedding layer 132, which convert the data from initial data into values embedding one or more data tables, matrices, or the like that represent the data in a processible format, vector, or the like for DNNs or ML models. Embedding layer 132 may include one or more data extraction and conversion process to word, phrase, or sentence embeddings, categorical data embeddings, and the like for data that may be processed and represented in the corresponding embedding table (e.g., for an item, purchase, or other past activity, event, or action). Attention layer 133 may be used in conjunction with the historical data and embedding to provide specific weights and focus, such as through a self-attention mechanism, to particular data records and/or data points in the training data. LSTM layer may encode the data to one or more of vectors 138, which may be used to represent the data but with a lower dimensionality through data encoding by an LSTM model and/or architecture. Use of an LSTM architecture may provide benefits for temporal-based predictions for data that may change over a time period and/or predictions that may be time-sensitive. As such, vectors 138 may retain temporal-based features and data. As such, vectors 138 may represent a compression of the input data, such as a transaction history of a user or other past activities of the user, that minimizes the size of the input vector while capturing all of the relevant information (e.g., the vector is capable of reducing a vector size while capturing all original data). This leads to a technical improvement where data input and processing sizes may be reduced while retaining the data's features, variables, and the like.

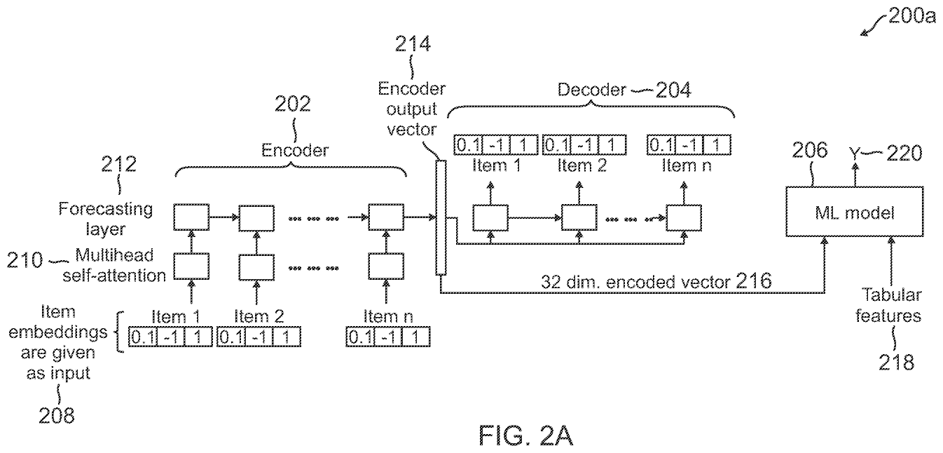

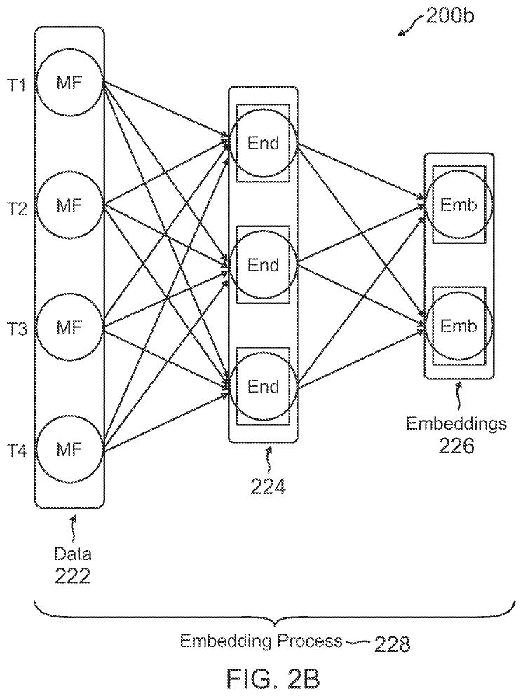

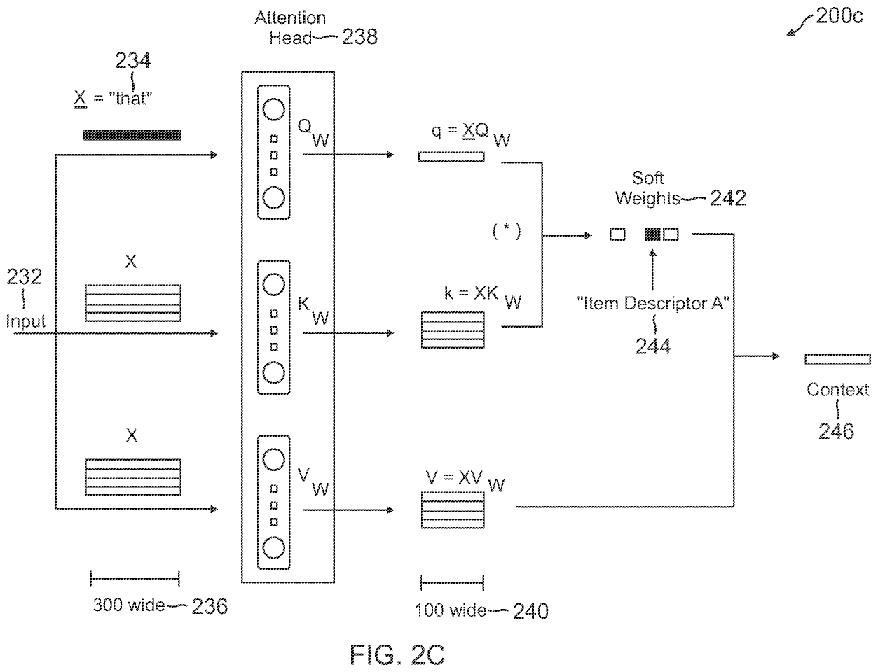

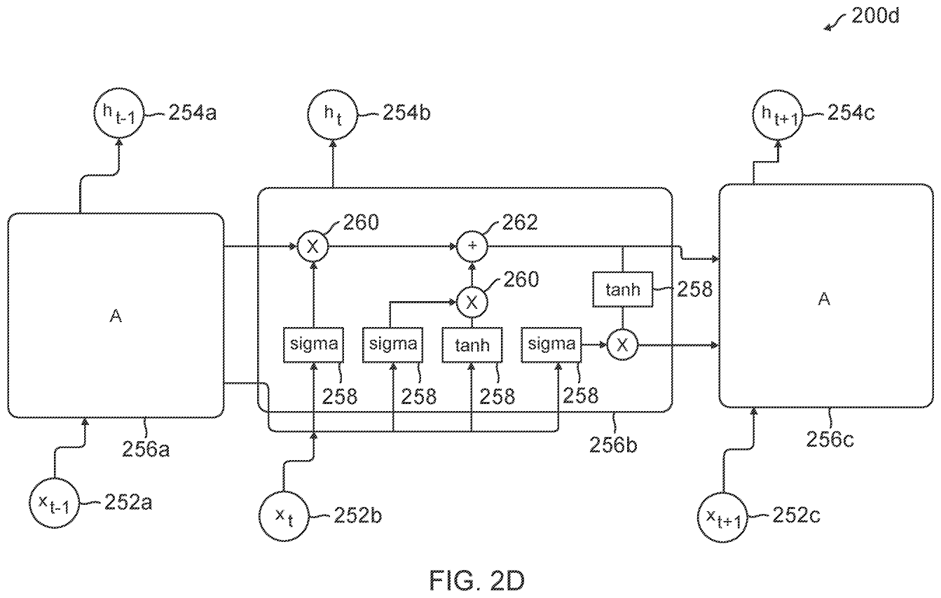

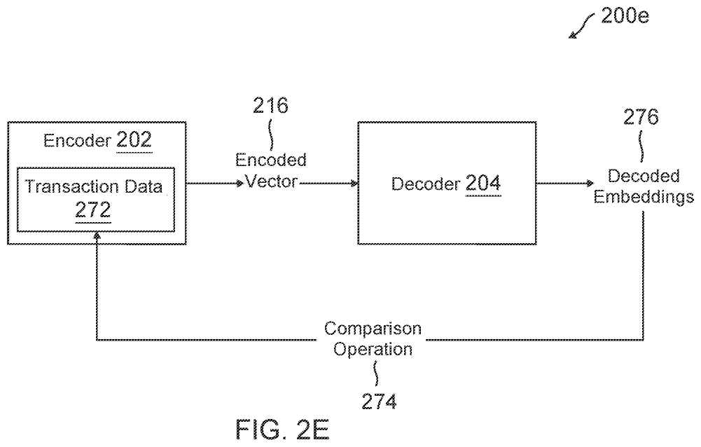

Decoder 135 may then be used to decode vectors 138, such as by utilizing an operation to reverse the vector encoding, as well as the feature embedding operations in some embodiments. Decoder 135 may recover the embeddings or feature data, which may be compared to the original data to determine comparisons 136 that may be analyzed to determine loss from encoding the data into a lower dimensionality vector, thereby reducing the number of input feature dimensions. Comparisons 136 may be used to determine whether encoder 131 is properly calibrated and functioning to produce vectors 138 of lower dimensionality while retaining the information from the underlying data. The layers of encoder 131 and use of encoder 131 to generate vectors 138, as well as decoding of vectors 138 by decoder 135 to check for loss, are discussed in more detail with regard to FIGS. 2A-4B below.

DNNs and/or ML models corresponding to models 139 may be trained using model trainer 137 with vectors 138. In this regard, vectors 138 may be provided as input and used to train one or more layers of a DNN or another ML model (e.g., decision trees or the like having branches in place of NN neurons). Models 139 may include one or more of layers, including an input layer, a hidden layer, and an output layer having one or more nodes, however, different layers may also be utilized. For example, decision trees having branches formed by decision nodes may instead be provided by models 139. As many hidden layers, nodes, and/or branches as necessary or appropriate may be utilized and the hidden layers. Each node within a layer is connected to a node within an adjacent layer, where a set of input values may be used to generate one or more output values or classifications. Within the input layer, each node may correspond to a distinct attribute or input data type that is used to train models 139, for example, using vectors 138.

Thereafter, the hidden layer(s) may be trained with these attributes and corresponding weights using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for models 139 that attempt to classify and/or categorize the input feature data and/or data records (e.g., for a user, account, activity, etc., which may be a predictive score or probability). This may be done by taking output values at the output layer and using one-hot encoding for categorization. Thus, when models 139 are used to perform a predictive analysis and output, the input may provide a corresponding output based on the classifications trained for models 139.

Models 139 may be trained by using vectors 138 from training data that have been encoded by encoder 131. By providing training of models 139, the nodes in the hidden layer(s) may be trained (adjusted) such that an optimal output (e.g., a classification) is produced in the output layer based on the training data. By continuously providing different sets of vectors 138 and penalizing models 139 when the output of models 139 is incorrect (e.g., below an accuracy threshold), models 139 (and specifically, the representations of the nodes in the hidden layer) may be trained (adjusted) to improve their performance in data classification. Adjusting models 139 may include adjusting the weights associated with each node in the hidden layer. Thus, vectors 138 may be used as input/output data sets that allow for models 139 to make classifications based on input attributes once trained.

Once trained, encoder 131, as well as decoder 135, may also be deployed for use in vector encoding during model predictions by models 139, such as in a production computing environment for transaction processing application 124. For example, encoder 131 may encode initial data for a user that is utilized to predict a risk or engagement score of the user, which may be associated with likelihood of the user's future action or inaction (e.g., meeting or failing to meet conditions or stipulations, including default likelihood on credit or loan extensions). For example, encoder 131 may take past activity data, such as a purchase history or past purchase and/or payments by a user, as input and produce a vector that may be input to one of models 139 for processing (e.g., by creating a vector of n-dimensionality for n reduced number of dimensions from the input features). This allows the vector to be generated having a temporal factor or dimension to the underlying data for the features, as well as reducing the dimension of the individual data points requiring clustering. Outputs of models 139 may be used by transaction processing application 124, or another application 122, to provide or extend a service or offer, or otherwise engage in electronic transaction processing and/or payment service operations with a user.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may include transaction processing application 124 that may be used by users associated with client device 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by transaction processing application 124. The digital accounts may be accessed and/or used through one or more instances of a web browser application and/or dedicated software application executed by client device 110 and engage in computing services provided by transaction processing application 124. Computing services of service applications 122 may also or instead correspond to messaging, social networking, media posting or sharing, microblogging, data browsing and searching, online shopping, and other services available through service provider server 120.

In various embodiments, service applications 122 may be desired in particular embodiments to provide features to service provider server 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including a graphical user interface (GUI), configured to provide an interface to the user when accessing service provider server 120 via one or more of client device 110, where the user or other users may interact with the GUI to view and communicate information more easily. In various embodiments, service applications 122 may include additional connection and/or communication applications, which may be utilized to communicate information to over network 140.

Additionally, service applications 122 may be used to provide a service or other information to one or more users or accounts based on risk and/or engagement scores determined by models 139. In this regard, service applications 122 may be used to provide offer 114 for a service, or other product and/or notification of such product to a user associated with client device 110. Offer 114 may correspond to a service of service application 122, such as on offer to use or access credit or a loan by the user. In various embodiments, the engagement score may correspond to usage of the services of service provider server 120, which may include a Recency, Frequency, and Monetary, Breadth, and Consistency (RFMBC) model score. The RFMBC score may be associated with a recency, frequency, and/or monetary value of past activities by the user, which may be used to determine parameters and/or products provided in offer 114 to client device 110.

Additionally, service provider server 120 includes database 126. Database 126 may store various identifiers associated with client device 110. Database 126 may also store account data, including payment instruments and authentication credentials, as well as transaction processing histories and data for processed transactions. Database 126 may store financial information or other data generated and stored by ML model platform 130. Database 126 may also include data and computing code, or necessary components for models 139, which may include vectors 138 and/or data used to determine vectors 138.

In various embodiments, service provider server 120 includes at least one network interface component 128 adapted to communicate client device 110 and/or other devices or server over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2E are exemplary computing architectures 200a-200e for a model training system and training components used to train ML models to predict user actions based on vectors generated using limited data availability, according to an embodiment. Computing architecture 200a displays an overview of a system and environment where a ML model 206 (e.g., light gradient-boosting machine (LGBM) model or other type of ML model) may be trained, such as by service provider server 120 using ML model platform 130 in system 100 of FIG. 1. As such, ML model 206 may correspond to one of models 139 deployed with transaction processing application 124 in system 100. In this regard, an encoder 202 may be used with a decoder for DNN or ML model training by encoding vectors from training data, which may be decoded to check loss from encoding. Encoder 202 may correspond to encoder 131 of ML model platform 130 for service provider server 120 in system 100.

Conventionally, LGBM model 206 may be trained using training data, which may include dimensionality of X based on the number of individual features corresponding to the features selected for ML model training. These features may be engineered and/or selected for the ML model task chosen and may be selected based on low or limited data availability scenarios, such as no banking or financial account historical data (e.g., account balances, incoming/outgoing payments, defaults or good balance standings, etc.). However, usage of such features may include many (e.g., hundreds or more) of individual features and therefore data points for the corresponding model, which may overly consume system resources during training and when deployed and performing forecasting. Further, too many data points may cause issues in training and/or may not properly be calibrated for the task at hand.

In this regard, encoder 202 may be used to generate an encoded vector 216 having 32 dimensions, although more or less dimensions may be selected based on the input features, loss, and the like. Item embeddings 208 are generated using an embedding layer, such as one shown in computing architecture 200b. In computing architecture 200b, embedding process 228 may take data 222 initially provided and generate embeddings 226 through an embedding network 224, where embeddings 226 represent a fixed dimension vector that may be processed to generate a lower dimensionality vector. For example, each circle or “node” in the input of data 222 shown in FIG. 2B may correspond to a model feature, where the input of data 222 may provide corresponding feature data for that feature (e.g., as a numerical or other mathematical representation of the data). Each arrow connecting the nodes for the features from data 222 to embedding network 224 represents a forward passthrough of processed data from the previous nodes. As such, data 222 is processed at corresponding feature nodes, such as using a mathematical function for embedding process 228, to provide data to a next node in embedding network 224. Embedding network 224 is then connected by the arrows to embeddings 226, where a further mathematical function operates on the data at the layer for embedding network 224 and provides the data to embeddings 226. The nodes in embeddings 226 may then have corresponding data used to generate a vector representation of data 222. As may layers, nodes, and/or branches as necessary for embedding process 228 may be used to create embeddings 226.

Embeddings 226 generated from data 222 may correspond to Fasttext embeddings, where embedding network 224 may correspond to a Fasttext network that takes each word (e.g., an item name in a purchase or transaction history) as input and provides the embedding for that word. Embedding process 228 may average the embeddings of all the words (e.g., in an item name) to get an embedding for that item name. Each word is converted into an embedding using the Fast-text network similar to the one shown in the FIG. 2B. Since the size of the vocabulary in data 222 may be large and the words in the categories may be transformed to a fixed dimension vector based on the selected features (e.g., 300 dimensions), a lower dimensionality vector may be preferable for model training and usage.

Further, data 222 may be reduced from a one-hot encoded vector of the size of vocabulary to the fixed dimension vector during embedding process 228. When performing embedding process 228, computing architecture 200c may be used to provide a multi-head self-attention mechanism 210 to the training data that applies a weighted focus to particular data points when creating embeddings 226. In this regard, attention head 238 in computing architecture 200c takes an input 232 having different words and produces a context 246 having applied weights and focus to particular words and terms based on importance and attention that may be increased or decreased for added relevance. Attention head 238 may correspond to a unit of a layer that may apply weights at an item/embedding level in the self-attention mechanism. For example, the words for an item name and/or description, such as words 234, may be used as input to each unit of self-attention mechanism to perform a word analysis 236 on each word with a weighted focus 240 on each word to determine soft weights 242. Weighted focus 240 may determine the similarity of one item or other information from past activities with other items or information given as input to other units of the self-attention mechanism. This may result in weights indicating how similar each item is with other items, or other correlations from past data. As such, an item descriptor A 244 may be provided additional weight in the corresponding training data, and context 246 may be output by multi-head self-attention mechanism 210. These weights may be used when calculating the new embedding for each item or other information. Item descriptor A 244 may correspond to words, phrases, sentences, and the like in an item title, item description, price, shipping or delivery, or the like, and may also or instead be associated with a purchase or payment, such as a price, purchase terms, communications and memoranda for the purchase, and the like. However, in further embodiments, item descriptor A 244 may more generally correspond to any word, name, phrase, group of words, or the like that has a corresponding definition or description.

To provide final output vectors, LSTM layer 212 may be utilized by encoder 202 to encode the attention weighted embeddings to vectors of reduced dimensionality, such as encoded vector 216 having 32 or other lower cardinality vector from the embeddings previously generated using the item or other data for past activities. In diagram 200d. LSTM layer 212 is shown in more detail where time-based inputs 252a-c may be processed to provide time-based outputs 254a-c corresponding to forecasts or predictions of data at different future timesteps or times based on temporal inputs. Time-based inputs may correspond to embeddings from time-based activity data and/or other temporal data that include time feature or variable to account for different data at different points in time. In LSTM layer 212, time-based inputs 252a-c may be taken at different points in time, which is not possible in a feedforward network. As such, time-based outputs 254a-c may have a corresponding time component based on processing by LSTM cells 256a-c. For example, LSTM cell 256b is shown having functions 258 that operate on data 260 to product a value 262 or other score, which may be used in time-base outputs 254b as well as fed to LSTM cell 256c for processing. Thus, the output vectors may have a corresponding time component based on the features determined using LSTM layer 212. Further, these output vectors provide a technical improvement by representing the initial input data in a smaller and/or compressed data form, thereby reducing input vector size during model training and use. The reduced size of the vectors retains the model features for accurate model training and predictions while being more efficient and requiring less computing resources based on smaller and compressed data sizes of vectors.

Encoder 202 may provide an output 214 having encoded vector 216, which represents the underlying data input to encoder 202 in a reduced dimensionality form. Prior to training of LGMB model 206 to provide ML model outputs 220 using encoded vector 216 with tabular features 218, decoder 204 may be used to check loss and ensure encoded vector 216 properly represents the underlying data for training of LGBM model 206. Encoder 202 may correspond to encoder 131 of ML model platform 130 for service provider server 120 in system 100. In diagram 200e, encoder 202 may obtain data 272, which it may encode to encoded vector 216 from embeddings generated as previously discussed. Decoder 204 may then utilize decoding operations that functionally reverse the encoding operations of encoder 202, which allows for retrieval of decoded embeddings 276.

A comparison operation 274 may then be used to compare the embeddings from data 272 generated by encoder 202 to decoded embeddings 276. Based on the comparison, a loss may be determined based on a difference in the embeddings and a similarity function or comparison, such as a vector comparison from embedding vectors. When meeting or exceeding a threshold similarity score or value, encoded vector 216 may be provided as input during training. However, if not, encoder 202 may be flagged for review and reconfiguring, and an accuracy or similarity measurement may be provided to further tune encoder 202. Thereafter, when encoded vector 216 and/or other vectors have been verified for training, LGBM model 206 may be trained. Training may include utilizing encoded vector 216 and tabular features 218 with an ML model training technique and system to train LGBM model 218 or other type of ML model, DNN, or the like to product outputs 220 that attempt to forecast or predict future user actions.

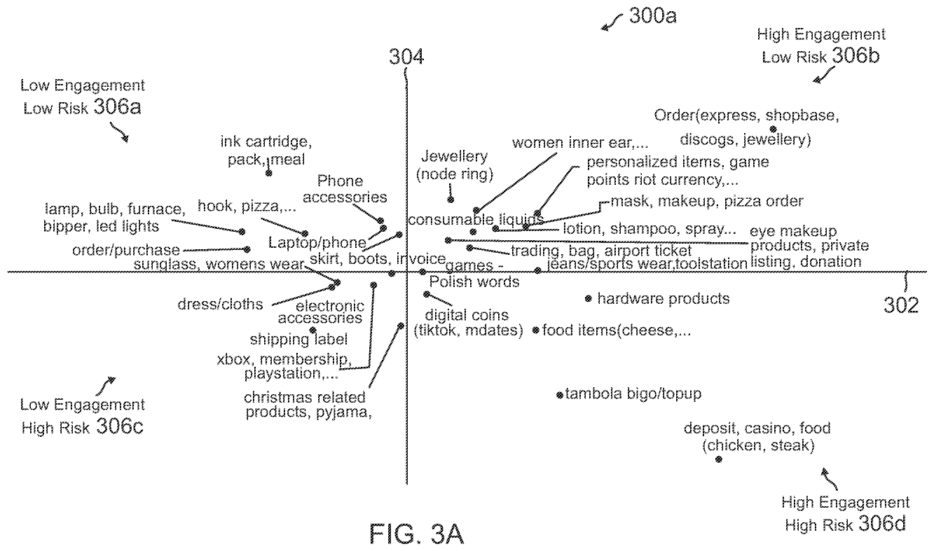

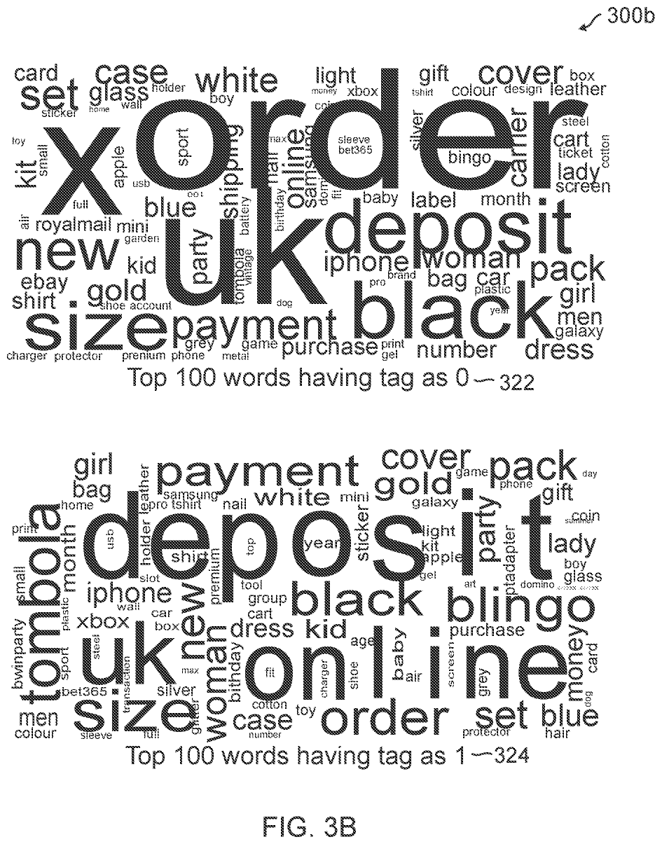

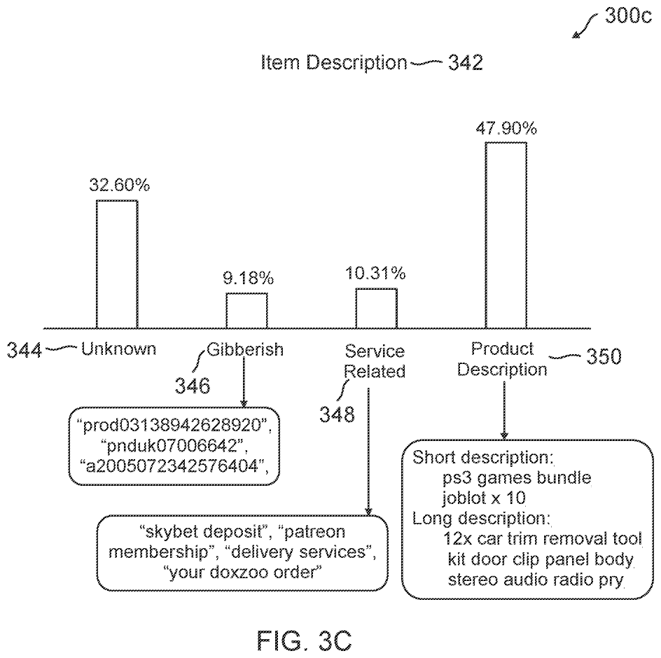

FIG. 3A-3C are exemplary diagrams 300a-300c of product descriptions from items in purchase histories of past purchases that may be used to encode vectors for forecasting of future user actions by ML models, according to an embodiment. Diagram 300a includes engagement scores 302 and risk scores 304 that may be output by service provider server 120 using models 139 discussed in reference to system 100 of FIG. 1 using the clustering operations discussed herein with DNN models. For example, in FIG. 3A, the actual values of future default behavior and future engagement may be seen. This may correspond to all items purchased in one or more calendar year and a relationships between those purchased items and whether a user defaulted or not. In this regard, service provider server 120 may generate engagement scores 302 and risk scores 304 based on input words, phrases, and/or sentences for past activities of users, which may be encoded to vectors and provided as input during training of models 139 and/or scoring of engagement scores 302 and risk scores 304 by models 139. As such, engagement scores 302 and risk scores 304 may correspond to identification of actual future engagement and risk, respectively, in the next time period based on the past time period. These may have a value (e.g., 5 to 25 or other set range), as well as a binary value (e.g., default or no default, engaged or not engaged).

In this regard, different words, phrases, sentences, and the like that are processed from activity histories of users may have different contributions to whether an offer should be extended to a user, as well as what the service offered to the user is. For example, different words and combinations of words may affect score calculation for a trained ML model by being relevant to or occurring more frequently with specific types or groups of users, such as those that may have a high or low engagement score and/or a high or low risk score. As such, ML models may output engagement scores 302 and risk scores 304, which may be organized, compared, and/or clustered in the graph shown in diagram 300a. Using such graphical representations, user categorizations 306a-d may be determined, which may be used to determine a service and/or offer of the service to provide to the user. As such, trained ML models as discussed herein may compute engagement scores 302 and risk scores 304 for determination of user categorizations 306a-d even with low or limited data availability, such as no banking of financial history, using the words and combination of words found in past activities of the user. As such, FIG. 3A shows that there is a relationship between past purchases and future behavior of the user and the past item purchases may be used as features in the model to predict the future behavior. FIG. 3B shows the relationship between an item purchase history ((e.g., based on word clouds corresponding to frequency of the words/items in item descriptions) and the future default behavior of the user (e.g., default=bad tag or no default=no bad tag), while not considering the engagement. FIG. 3C may show the general distribution of item purchases by users, where Unknown and Gibberish may be cases where the name of the actual item purchased is unknown and the legitimate name of the items purchased by the user is known in only 60% of cases.\

In diagrams 300b and 300c, item descriptions from past activities, such as past purchases or a transaction history of one or more users, is shown as contributing to engagement scores 302 and risk scores 304 from diagram 300a. For example, first word cloud 322 indicates a set of 100 words having a tag set as zero, while second word cloud 324 indicates a set of 100 words having a tag set as one. First word cloud 322 may be set as zero to provide or compute a lower risk and/or engagement score when utilized in descriptions or information for past activities of a user (e.g., item descriptions from past purchases), while second word cloud 324 may be set to one to increase a computed risk and/or engagement score. As such, item descriptions 342 show word content percentages in past activities, which include unknown content 344, gibberish content 346, service-related content 348, and/or product description content 350, which may be weighted depending on an ML model algorithm and/or attention layer when encoding vectors for model training and predicting. Diagrams 300b and 300c may show word clouds that may be used as input features for item purchase history, which may be used for encoding vectors to train ML models.

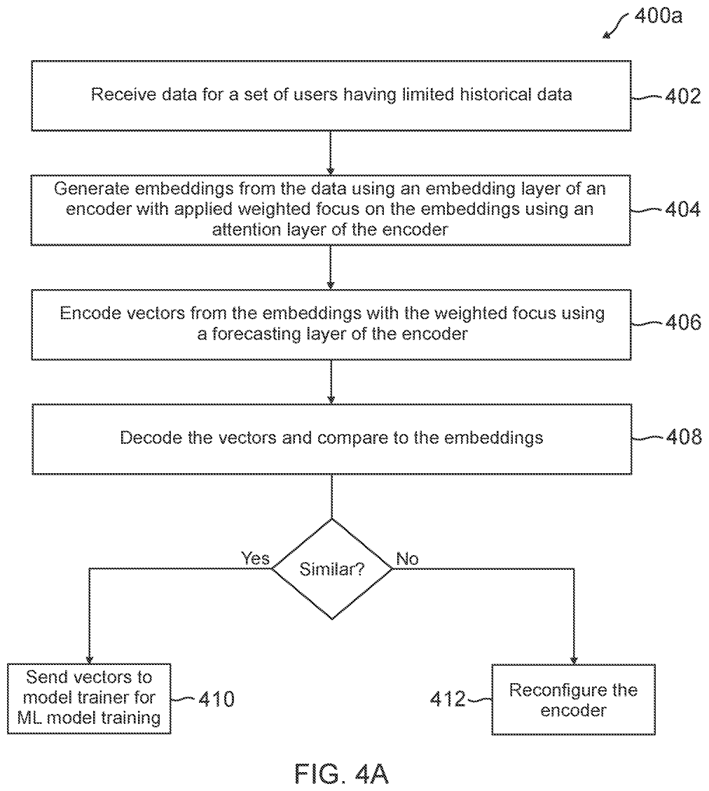

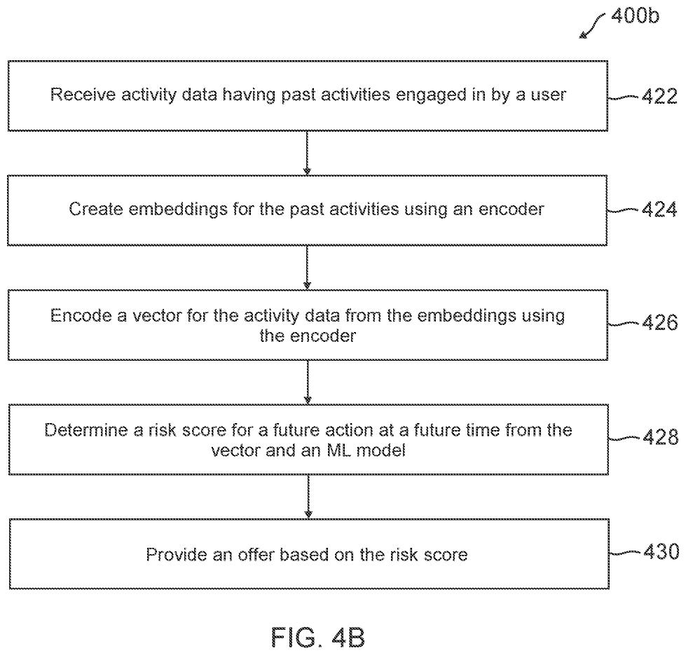

FIGS. 4A-4B are exemplary flowcharts 400a and 400b for forecasting with limited data availability utilizing embeddings from auto-encoders and machine learning models. Note that one or more steps, processes, and methods described herein of flowcharts 400a and 400b may be omitted, performed in a different sequence, or combined as desired or appropriate. Flowcharts 400a and 400b of FIGS. 4A and 4B includes operations for determining predictions and forecasts of future user actions, behaviors, and/or activities utilizing ML models trained using embeddings from auto-encoders, as discussed in reference to FIG. 1-3C above. One or more of steps 402-430 of flowcharts 400a and 400b may be implemented, at least in part, in the form of executable code stored on non-transitory, tangible, machine-readable media that when run by one or more processors may cause the one or more processors to perform one or more of steps 402-430. In some embodiments, flowcharts 400a and 400b may be performed by one or more computing devices, servers, and/or systems discussed in system 100 of FIG. 1.

Flowchart 400a represents exemplary training of a DNN or other ML model for forecasting using encoded vectors. At step 402 of flowchart 400a, data for a set of users having limited historical data is received. For example, service provider server 120 may receive and/or access activity data for a group or plurality of users including those users or customers of the service provider, which may include past activities of the user. The past activities may include past transactions or past purchases by a user, where the user may have limited past financial or banking data making forecasting of future default likelihood difficult using conventional systems and models. The activity data may include feature data for features selected for an ML model, which may be encoded into a vector. In this regard, data 222 may represent the activity data that is received. The data may include different words, descriptions, and/or messages, which may designate a user's risk and/or engagement. For example, diagrams 300a-c demonstrate exemplary words, descriptions and/or word embeddings that may correspond to the received data.

At step 404, embeddings are generated from the data using an embedding layer of an encoder with applied weighted focus on the embeddings using an attention layer of the encoder. Embeddings 226 may be determined by service provider server 120 using embedding layer 132 of encoder 131 from the data records for the feature data. Using the input feature data, the embeddings may be generated to mathematically represent the underlying data and allow for processing. Attention head 238 of attention layer 133 may provide a unit that processes the data to determine data records and/or features from the data records that are designated for additional weighted focus, such as those that may repeat or be of importance in the dataset. In this regard, soft weights 242 may be applied when generating the embeddings to provide embedding values that have a weighted focus relevant to the ML task being performed.

At step 406, vectors are encoded from the embeddings with the weighted focus using a forecasting layer of the encoder. Vectors 138 may be generated for training of models 139 based on outputs by forecasting layer 134. In this regard, vectors 138 may correspond to the outputs of a forecasting model, such as an LSTM or other model shown in diagram 200d, where time-based outputs 254a-c are provided at different times from time-based inputs 252a-c. At step 408, the vectors are decoded and compared to the embeddings. Decoder 135 may be utilized to decode vectors 138 to check loss from encoding and whether vectors 138 align with and represent the underlying data first received. In various embodiments, the forecasting layer may correspond to an LSTM layer and corresponding LSTM model and forecasting operations, however, other temporal-based ML models and NNs may also be used.

If the decoded vectors are similar to the embeddings, the vectors are sent to a model trainer for ML model training, at step 410. Model trainer 137 may receive vectors 138 and train models 139 using such vectors. Once trained, models 139 may be deployed in a production computing environment, such as with transaction processing application 124 for service applications 122. However, if the decoded vectors are not similar to the embeddings, the encoder is reconfigured for improved vector generation and encoding, at step 412. For example, encoder 131 may be reconfigured in order to better generate vectors 138 that may represent the underlying data. As such, decoder 135 may be utilized to check loss from encoding and ensure encoder 131 is being used properly to provide accurate decisions reflecting the underlying data.

As discussed above and further emphasized here, flowchart 400a of FIG. 4A may be executed by service provider server 120 when training one or more ML models using ML model platform 130 and corresponding methods for ML model training to forecast outputs with limited data availability utilizing embeddings from auto-encoders and machine learning models, which examples should not be used to unduly limit the scope of the claims. One of ordinary skill in the art would recognize many variations, alternatives, and modifications.

Flowchart 400b represents exemplary usage of a DNN or other ML model for forecasting using encoded vectors. At step 422 of flowchart 400b, activity data having past activities engaged in by a user are received. For example, service provider server 120 may receive and/or access activity data for a user, such as past transactions or past purchases by a user, where the user may have limited past financial or banking data making forecasting of future default likelihood difficult using conventional systems and models. The activity data may include feature data for features selected for an ML model, which may be encoded into a vector. In this regard, data 222 may represent the activity data that is received.

At step 424, embeddings for the past activities are created using an encoder. Service provider server 120 may execute encoder 131 of ML model platform 130 to encode vectors from the activity data, which may be used for forecasting the user's activity, behavior, or actions at a future time, such as a default likelihood on credit or a loan by the user. In this regard, data 222 may be converted to embeddings 226 using one or more operations of embedding layer 132 to convert the data to mathematical representations that may be used for vector encoding. Further, attention layer 133 may be provided, which may include attention head 238 for a self-attention mechanism that adds soft weights 242 to the corresponding words or other data for the embeddings.

At step 426, a vector for the activity data is encoded from the embeddings using the encoder. The vector may be encoded using encoder 131, such as through forecasting layer 134, using the embeddings with weighted focus from the self-attention mechanism of embedding layer 132 with attention layer 133. These components may be used to generate time-based outputs 254a-c at different times from time-based inputs 252a-c, which provide an output vector used with models 139. As such, an application, such as transaction processing application 124, may execute models 139 using the encoded vector in order to generate an output.

At step 428, a risk score for a future action at a future time is determined from the vector and an ML model. For example, service provider server 120 may determine risk scores using models 139 with transaction processing application 124 or another of service application 122 in order to determine offer 114 for a service that may be provided to the user associated with client device 110. The risk score may be utilized with or include an engagement score, where users may be compared to determine different user categorizations 306a-d that rank or classify users based on engagement scores 302 and risk scores 304. Although user categorizations 306a-d are based on actual future default behavior and engagement values, calculated risk and engagement scores may be used. At step 430, an offer is provided based on the risk score. In this regard, the diagram 300a demonstrates engagement scores 302 and risk scores 304, which may be based on corresponding words from purchase histories or other data to predict user actions at future times. The offer may be based on the likelihood or prediction of a future user action, such as default likelihood or another forecast of the user's behavior, risk, and/or engagement at a future time. The offer may be to extend a loan or credit to the user, or otherwise obtain use of a financial and/or computing service of service provider server 120.

As discussed above and further emphasized here, flowchart 400b of FIG. 4B may be executed by service provider server 120 when utilizing one or more ML models through ML model platform 130 and corresponding methods for forecasting outputs with limited data availability utilizing embeddings from auto-encoders and machine learning models, which examples should not be used to unduly limit the scope of the claims. One of ordinary skill in the art would recognize many variations, alternatives, and modifications.

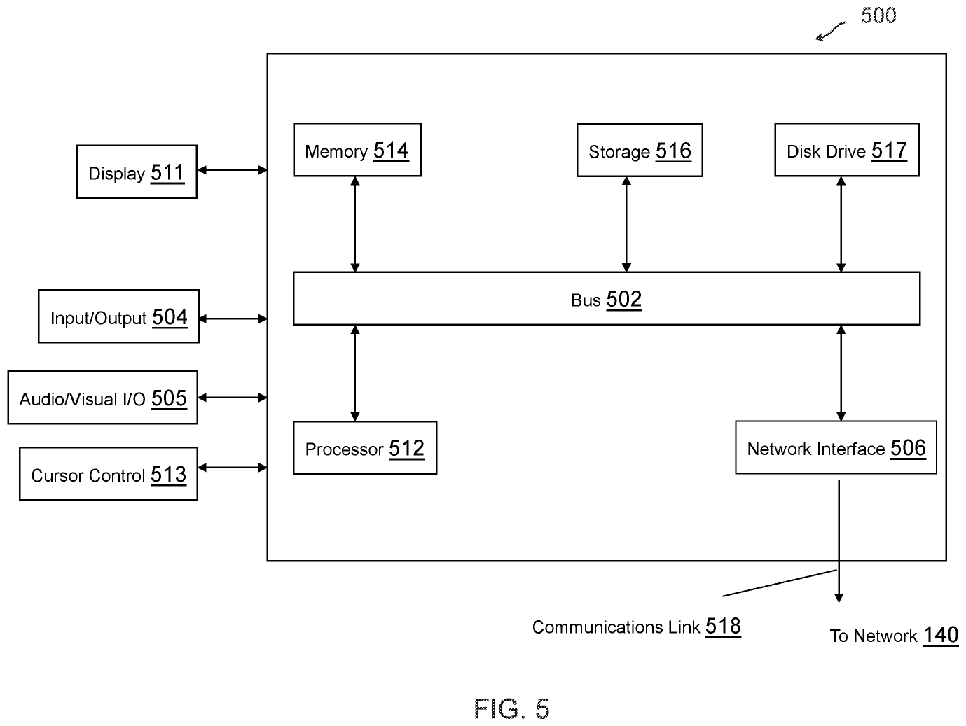

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving activity data for a plurality of model features associated with a machine learning (ML) model, wherein the activity data is associated with past activities of a user;
generating, using an encoder associated with the ML model, a first plurality of embeddings associated with the plurality of model features from the activity data;
encoding, using the encoder, a vector from the first plurality of embeddings, wherein the encoding includes utilizing a forecasting ML layer for output of the vector;
calculating, using the ML model, a risk score based on the vector, wherein the ML model is trained based on a plurality of other past activity vectors generated by the encoder using training data associated with other past activities for a plurality of other users;
analyzing the risk score from the ML model; and
determining, based on the analyzing, a predicted likelihood of the user meeting or failing to meet a condition for a service offered to the user at a future time.

2. The system of claim 1, wherein the operations further comprise:
providing an offer of the service to the user based on whether the predicted likelihood meets or exceeds a threshold likelihood score.

3. The system of claim 2, wherein, prior to the providing the offer, the operations further comprise:
predicting an engagement score of the user based on the risk score and the past activities, wherein the engagement score is associated with a usage of a service provider corresponding to the service by the user, and wherein the providing the offer is further based on the engagement score.

4. The system of claim 3, wherein the engagement score comprises a Recency, Frequency, and Monetary, Breadth, and Consistency (RFMBC) model score associated with a recency of each of the past activities, a frequency of the past activities, and a monetary value associated with each of the past activities.

5. The system of claim 1, wherein the generating the embedding comprises:
converting description data for the past activities to the plurality of first embeddings using at least one data embedding process, wherein the at least one data embedding process converts text data to numerical representations in the plurality of first embeddings.

6. The system of claim 1, wherein, prior to the generating the first plurality of embeddings, the operations further comprise:
in response to receiving the activity data, determining that the activity data is designated for processing by the ML model;
determining, for the ML model, a multi-layer ML architecture comprising the encoder and a decoder associated with the encoder, wherein the encoder includes at least an embedding layer that generates the first plurality of embeddings, an attention layer that applies weights to the first plurality of embeddings, and the forecasting ML layer; and
executing the encoder for the generating the first plurality of embeddings.

7. The system of claim 6, wherein the forecasting ML layer comprises a long-short term memory (LSTM) model configured to encode the vector, and wherein the attention layer comprises a multi-headed self-attention mechanism configured to apply the weights to the first plurality of embeddings based on time-based data.

8. The system of claim 1, wherein, prior to the receiving the activity data, the operations further comprise:
training the ML model using the plurality of other past activity vectors in place of mode feature data from the training data for the plurality of model features, wherein the plurality of other past activity vectors are configured to reduce a dimensionality of the plurality of model features in the training data to a n-dimensional vector.

9. The system of claim 8, wherein, prior to the training, the operations further comprise:
decoding, using a decoder associated with the encoder, the plurality of other past activity vectors to a second plurality of embeddings;
comparing the first plurality of embeddings to the second plurality of embeddings; and
determining whether to provide the plurality of other past activity vectors for the training of the ML model based on the comparing.

10. The system of claim 8, wherein the training data comprises time-based activity data for the plurality of users that are not associated with banking account information, and wherein the plurality of model features comprise at least a portion of default risk features for risk assessment.

11. A method comprising:
receiving activity data for a user, wherein the activity data comprises historical activities by the user over a time period;
extracting model feature data for a plurality of model features associated with a machine learning (ML) model from the activity data;
generating a plurality of embeddings for the plurality of model features from the activity data, wherein the plurality of embeddings are each associated with individual activities from the historical activities by the user over the time period;
applying an attention layer to the plurality of embeddings, wherein the attention layer applies weights on particular features from the plurality of model features in the plurality of embeddings;
generating, using a long-short term memory (LSTM) model, a vector from the plurality of embeddings, wherein the generating includes utilizing an ML layer for output of the vector;
providing the vector to the ML model, wherein the ML model is trained using a plurality of other past activity vectors associated with additional historical activities by a plurality of other users; and
determining, using the ML model based on the providing, a risk score of the user for failing to meet a required stipulation of a service extended to the user at a future time.

12. The method of claim 11, wherein the attention layer comprises a multi-headed self-attention mechanism for the weights on the particular features.

13. The method of claim 11, wherein the LSTM model is configured for a transaction forecasting associated with the activity data and the additional historical activities.

14. The method of claim 11, further comprising:
generating an engagement score for the user based on the risk score and the historical activities; and
providing an offer for the service to the user based on the engagement score.

15. The method of claim 11, wherein, prior to the receiving the activity data, the method further comprises:
generating the plurality of other past activity vectors using an encoder comprising an embedding layer associated with generating the plurality of embeddings, the attention layer, and the LSTM model; and
training the ML model using the plurality of other past activity vectors.

16. The method of claim 15, further comprising:
decoding the plurality of other past activity vectors;
comparing the decoded plurality of other past activity vectors to the plurality of embeddings; and
determining that the decoded plurality of other past activity vectors correlates to the plurality of embeddings within a similarity threshold.

17. A non-transitory machine-readable medium having stored thereon machine-readable instructions executable to cause a machine to perform operations comprising:
receiving data associated with past activities of a user;
generating, using an encoding operation of a machine learning (ML) framework, a plurality of embeddings for activity features of the past activities based on the data;
generating, using an ML layer of the ML framework, a vector encoded from the plurality of embeddings; and
forecasting, using the ML framework, a likelihood of a user action by the user at a future time based on the vector, wherein the forecasting is performed using an ML model trained using a plurality of other vectors generated using additional past activities of a plurality of other users.

18. The non-transitory machine-readable medium of claim 17, wherein, prior to the forecasting, the operations further comprise:
determining, using a decoding operation of the ML framework, a plurality of decoded embeddings from the vector; and
comparing the plurality of embeddings to the plurality of decoded embeddings.

19. The non-transitory machine-readable medium of claim 18, wherein, prior to the forecasting, the comparing is required to meet a similarity threshold.

20. The non-transitory machine-readable medium of claim 18, wherein the operations further comprise:
providing a notification associated with an encoding accuracy of the encoding operation based on the comparing.
